(19) United States
(12) Patent Application Publication
(10) Pub. No.: US 2014/0204843 A1
(43) Pub. Date: Jul. 24, 2014

(54) Reliable PDSCH Decoding on Cross-Scheduled Carrier during Random Access Procedure

(71) Applicants: Daniel Larsson, Stockholm (SE); Robert Baldemair, Solna (SE); Mattias Frenne, Uppsala (SE); Mikael Wittberg, Uppsala (SE)

(72) Inventors: Daniel Larsson, Stockholm (SE); Robert Baldemair, Solna (SE); Mattias Frenne, Uppsala (SE); Mikael Wittberg, Uppsala (SE)

(73) Assignee: TELEFONAKTIEBOLAGET LM ERICSSON (PUBL), Stockholm (SE)

(21) Appl. No.: 13/520,307

(22) PCT Filed: Apr. 25, 2012
(86) PCT No.: PCT/SE12/50429

§ 371 Date: Jul. 2, 2012

Related U.S. Application Data
(60) Provisional application No. 61/542,535, filed on Oct. 3, 2011.

(51) Int. Cl. H04W 74/08

(52) U.S. Cl. CPC H04W 74/0833
USPC 370/329

(57) ABSTRACT

In an LTE network (10) employing carrier aggregation, a cross-scheduled UE (16) may initiate a random access procedure on a secondary component carrier (SCC) by transmitting a random preamble on the UL SCC PRACH. Contrary to normal cross-scheduling procedure—in which the UE (16) reads PDCCH on PCC and PDSCH on SCC using a provisioned pdsch-Start parameter—the UE (16) reads PCFICH directly on the DL SCC to obtain the CFI. The UE (16) uses the DL SCC CFI to access the PDSCH to read a message from the network (10) specifying a timing advance value for the UE (16) to use on UL SCC. For other DL SCC traffic, the UE (16) reads the DL PCC PDCCH and uses the pdsch-Start parameter to locate PDSCH on SCC.

This application claims priority to U.S. Provisional Patent Application No. 61/542,535, filed Oct. 3, 2011, the disclosure of which is incorporated herein by reference in its entirety.

### TECHNICAL FIELD

The present invention relates generally to wireless communication networks, and in particular to a system and method of reliably decoding PDSCH on a cross-scheduled carrier during a random access procedure by reading a CFI value on the cross-scheduled carrier.

### BACKGROUND

Wireless communication networks are ubiquitous in many parts of the world. Such networks operation according to several standardized protocols, such as WCDMA, cdma2000, GSM, WiMAX, and the like. A fourth-generation wireless communication network protocol, developed and promulgated by the 3^{rd} Generation Partnership Project (3GPP) is the Long Term Evolution (LTE). LTE is based on the GSM/EDGE and UMTS/HSPA network technologies. LTE, which is under continuous development and standardized in a succession of “releases,” provides increased capacity and speed, enabling an ever-expanding set of wireless services, improved call quality, and reduced battery power consumption for mobile User Equipment (UE).

Like all cellular wireless communication networks, LTE deploys a plurality of base stations—referred to as enhanced node B (eNB)—each of which provides wireless communication services over a geographic area, or cell. UE within a cell will, in general, be located at varying distances from the eNB antenna(s). Accordingly, radio frequency (RF) signals between the eNB and different UEs will have different travel times. The LTE protocol provides a procedure, executed when a UE requests access to the network, for the eNB to measure the travel time of signals from each UE. The eNB then calculates and transmits to each UE a timing adjustment value, by which the UE's transmissions to the eNB should be offset, resulting in signals from all UE MSL arriving at the eNB at (approximately) the same time.

To provide maximum flexibility in the deployment of LTE systems throughout various jurisdictions, Release 10 of the LTE specification defines carrier aggregation, in which multiple, possibly non-frequency-contiguous, RF carriers may be employed to provide increased bandwidth, capacity, and throughput. According to the standard, a UE accesses the network on a primary component carrier (PCC), and may then be assigned one or more secondary component carriers (SCC). If a UE can access multiple component carriers it can be scheduled in on these according to various mechanisms. The standard mechanism is that the UE receives DL assignments and uplink grants on a PDCCH that is located on the same component carrier as the PDSCH or SIB2-linked UL carrier. The second mechanism referred to herein as cross-scheduling, is when the UE can receive DL assignments and/or UL grants on a different component carrier or component pair than that for which the DL assignments or UL grants are valid. A component carrier pair constitutes a DL component carrier that is linked with UL component carrier with SIB2 signalling. The antenna(s) on which the SCC is transmitted and received may or may not be co-located with the antenna(s) for the PCC at the eNB. Accordingly, for a given UE in a cell, RF signal travel time for the PCC and SCC may not be the same; hence, the UE should not use the same timing advance value on the different component carriers.

Several aspects of the LTE Release 10 standard—including the restriction of random access procedures to the PCC and a pre-defined control channel element search pattern—preclude the efficient transmission of a SCC timing advance value to a cross-scheduled UE in case multiple timing advanced is needed.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure is not intended to identify key/critical elements of embodiments of the invention or delineate the scope of the invention. The sole purpose of this summary is to present some concepts disclosed herein in a simplified form as a prelude to the more detailed description that is presented later.

According to one or more embodiments described and claimed herein, a cross-scheduled UE may perform a random access procedure on a SCC by transmitting a random preamble on the UL SCC PRACH. Contrary to normal cross-scheduling procedure—in which the UE reads PDCCH on PCC and PDSCH on SCC using a provisioned pdsch-Start parameter—the UE reads PCFICH directly on the DL SCC to obtain the CFI. The UE uses the DL SCC CFI to access the PDSCH to read a message from the network specifying a timing advance value for the UE to use on UL SCC(s). For other DL SCC traffic, the UE reads the DL PCC PDCCH and uses the pdsch-Start parameter to locate PDSCH on SCC.

In one embodiment, the present invention relates to method, by a UE, of obtaining timing advance information on a SCC, when the UE is scheduled on a PCC. A random access preamble is sent to the network on a PRACH of the SCC. A CFI is obtained from the PCFICH of the SCC. Based the SCC CFI, the UE ascertains the start of the PDSCH, and reads at least a random access response message (MSG2) on the PDSCH of the SCC. A timing advance value is then obtained from the MSG2.

In another embodiment, the present invention relates to method, by an eNodeB, the present invention relates to method of transmitting timing advance information on a SCC to UE, where the UE is scheduled on a PCC. A random access preamble is received from the UE on a PRACH of the SCC. A timing advance value for the UE is calculated based on the timing of receipt of the random access preamble on the SCC PRACH. A Control Format Indicator is transmitted on a PCFICH of the SCC. A random access response message, MSG2, is transmitted on the PDSCH of the SCC, wherein the MSG2 includes the calculated timing advance value.

In yet another embodiment, the present invention relates to a UE operative in a LTE wireless communication network employing carrier aggregation. The UE includes one or more antenna; a transceiver operatively connected to the antenna; memory; and a controller operatively connected to the transceiver and memory. The controller is operative to establish communication with an eNodeB and receive scheduling on a PCC, including cross-scheduling to a SCC. The controller is further operative to cause the transmitter to send to the network a random access preamble on a PRACH, of the SCC, and to cause the transmitter to obtain a CFI from the PCFICH of the SCC. Based the SCC CFI, the controller is operative to ascertain the start of the PDSCH; cause the transmitter to read at least a random access response message, MSG2, on the PDSCH of the SCC; and obtain a timing advance value from the MSG2.

In still another embodiment, the present invention relates to an eNodeB operative in a LTE wireless communication network employing carrier aggregation. The eNodeB includes one or more antenna; a transceiver operatively connected to the antenna; memory; and a controller operatively connected to the transceiver and memory. The controller is operative to establish communication with a UE, and schedule the UE on a PCC, and further operative to cross-schedule the UE on a SCC. The controller is further operative to cause the transmitter to receive from the UE a random access preamble on a PRACH of the SCC, and to calculate a timing advance value for the UE based on the timing of receipt of the random access preamble on the SCC PRACH. The controller is further operative to cause the transmitter to transmit a CFI on a PCFICH of the SCC, and to cause the transmitter to transmit a random access response message, MSG2, on the PDSCH of the SCC. The MSG2 includes the calculated timing advance value.

### BRIEF DESCRIPTION OF THE DRAWINGS

FIG. 1 is a functional block diagram of an LTE wireless communication network.

FIG. 2 is a time-frequency diagram of an OFDM downlink signal.

FIG. 3 is a graph depicting LTE frames and subframes.

FIG. 4 is a time-frequency diagram depicting control and reference signaling.

FIG. 5 is a frequency graph depicting carrier aggregation.

FIG. 6 is a cell diagram depicting different signal round-trip travel times.

FIG. 7 is a timing diagram depicting timing advance.

FIG. 8 is a time-frequency diagram depicting RACH channel.

FIG. 9 is a signaling diagram depicting a contention-based random access procedure.

FIG. 10 is a cell diagram depicting contention in a random access procedure.

FIG. 11 is a signaling diagram depicting a contention-free random access procedure.

FIG. 12 is a diagram depicting aggregation levels and search spaces.

FIG. 13 is a flow diagram of the processing of control channel elements.

FIG. 14 is a flow diagram of a method of reliably transmitting timing adjustments on SCC.

FIG. 15 depicts functional block diagrams of an eNodeB and a UE.

### DETAILED DESCRIPTION

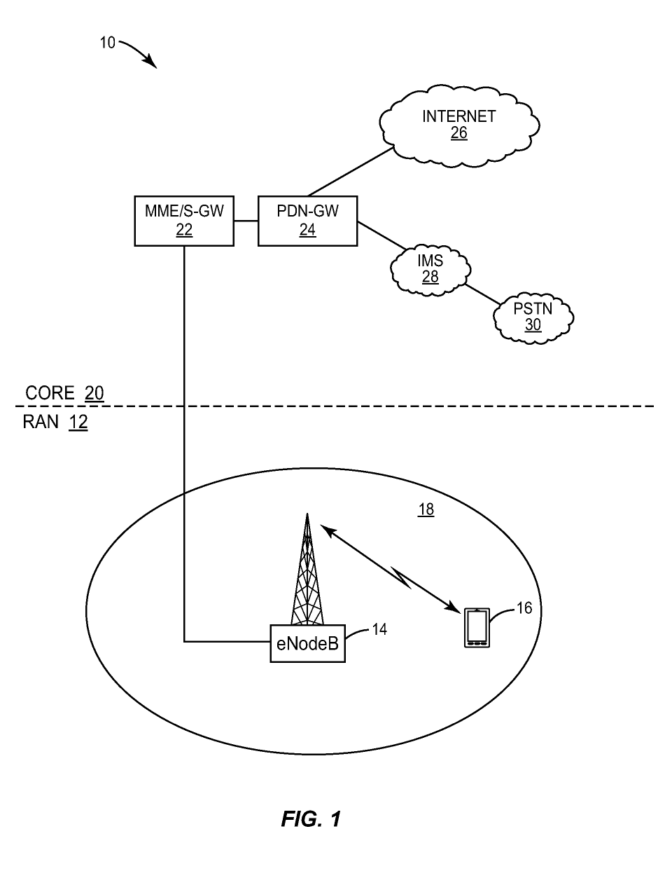

FIG. 1 depicts a high-level, functional block diagram of a LTE wireless communication network 10. A Radio Access Network (RAN) 12, e.g., E-UTRAN, comprises one or more base stations, or eNodeBs 14. Each eNodeB 14 provides wireless communication service to a plurality of User Equipment (UE) 16 within a geographical area, or cell 18. A core network 20 comprises a plurality of communicatively-linked nodes, such as a Mobility Management Entity (MME) and Serving Gateway (S-GW) 22. The MME-S-GW 22 connects to numerous nodes (not all of which are depicted for simplicity), including a Packet Data Network Gateway (PDN-GW) 24. The PDN-GW 24 provides connectivity to packet data networks such as the Internet 26, and through an IP Multimedia Subsystem (IMS) 28 to the Public Switched Telephone Network (PSTN) 30.

### LTE Channel Structure

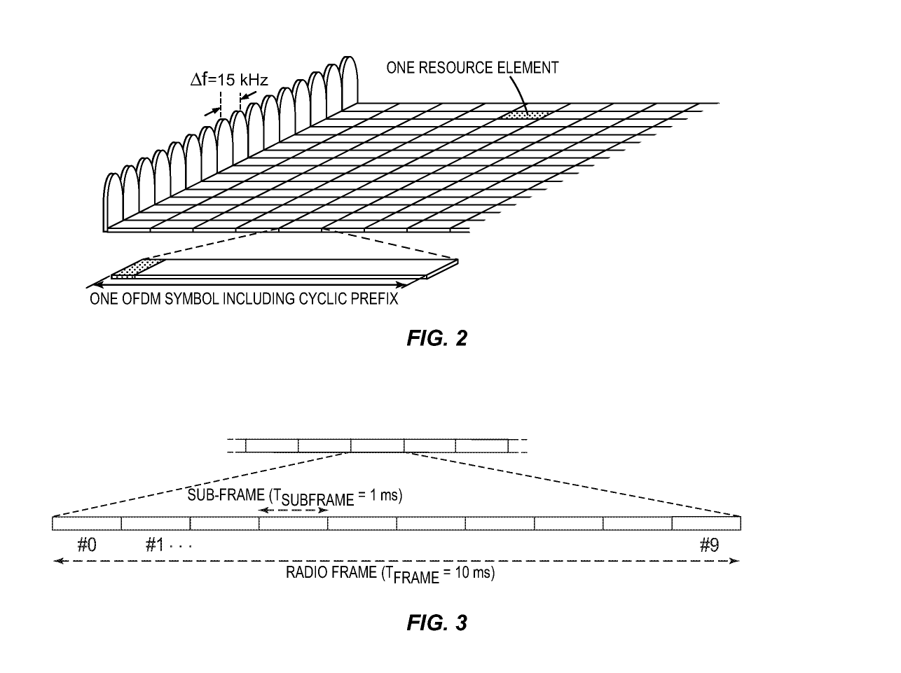

As mentioned above, LTE uses OFDM modulation in the downlink (and DFT-spread OFDM in the uplink). The basic LTE downlink physical resource can thus be seen as a time-frequency grid as illustrated in FIG. 2. Each resource element corresponds to one OFDM subcarrier (15 KHz) during one OFDM symbol interval.

In the time domain, LTE downlink transmissions are organized into radio frames of 10 ms, each radio frame consisting of ten equally-sized subframes of length T_{subframe}=1 ms, as illustrated in FIG. 3.

Resource allocation in LTE is typically described in terms of resource blocks (RB), where a resource block corresponds to one slot (0.5 ms) in the time domain and 12 contiguous subcarriers in the frequency domain. A pair of two adjacent resource blocks in the time direction (1.0 ms) is known as a resource block pair. Resource blocks are numbered in the frequency domain, starting with 0 from one end of the system bandwidth.

The notion of virtual resource blocks (VRB) and physical resource blocks (PRB) has been introduced in LTE. The actual resource allocation to a UE is made in terms of VRB pairs. There are two types of resource allocations, localized and distributed. In the localized resource allocation, a VRB pair is directly mapped to a PRB pair; hence two consecutive and localized VRB are also placed as consecutive PRBs in the frequency domain. On the other hand, the distributed VRBs are not mapped to consecutive PRBs in the frequency domain, thereby providing frequency diversity for data channel transmitted using these distributed VRBs.

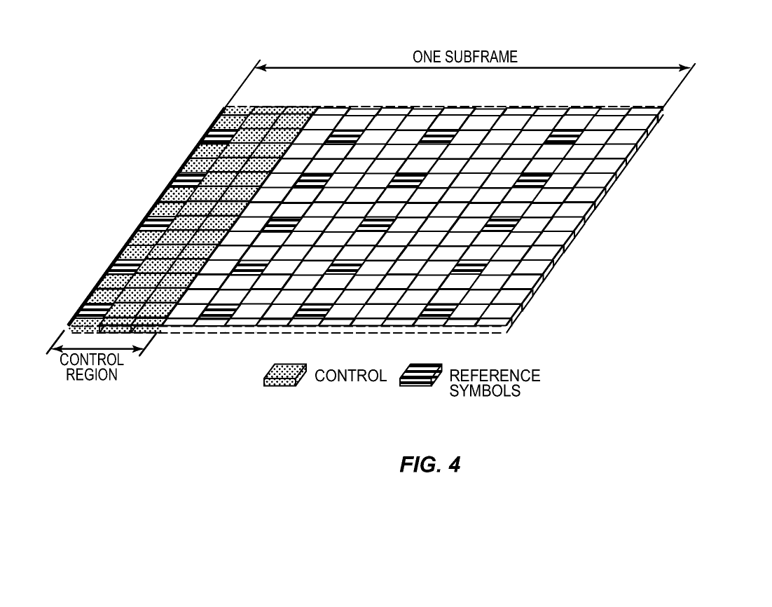

Downlink transmissions are dynamically scheduled, i.e., in each subframe the base station transmits control information specifying to which UE data is transmitted, and on which resource blocks, in the current downlink subframe. This control signaling is typically transmitted in the first 1, 2, 3 or 4 OFDM symbols in each subframe and the number n=1,2,3 or 4 is known as the Control Format Indicator (CFI). The CFI is transmitted as the first symbol in the control channel, and is assigned the logical channel Physical Control Format Indicator Channel (PHFICH). The downlink subframe also contains common reference symbols (CRS), which are known to the receiver and used for coherent demodulation of e.g. the control information. A downlink system with CFI=3 OFDM symbols as control is illustrated in FIG. 4.

### LTE Carrier Aggregation

As mentioned above, Release 10 of LTE defines carrier aggregation. In particular, Rel-10 supports Component Carrier (CC) bandwidths up to 20 MHz (which is the maximum LTE Rel-8 carrier bandwidth). Hence, an LTE Rel-10 operation wider than 20 MHz is possible, and appears as a plurality of LTE carriers to an LTE Rel-10 UE.

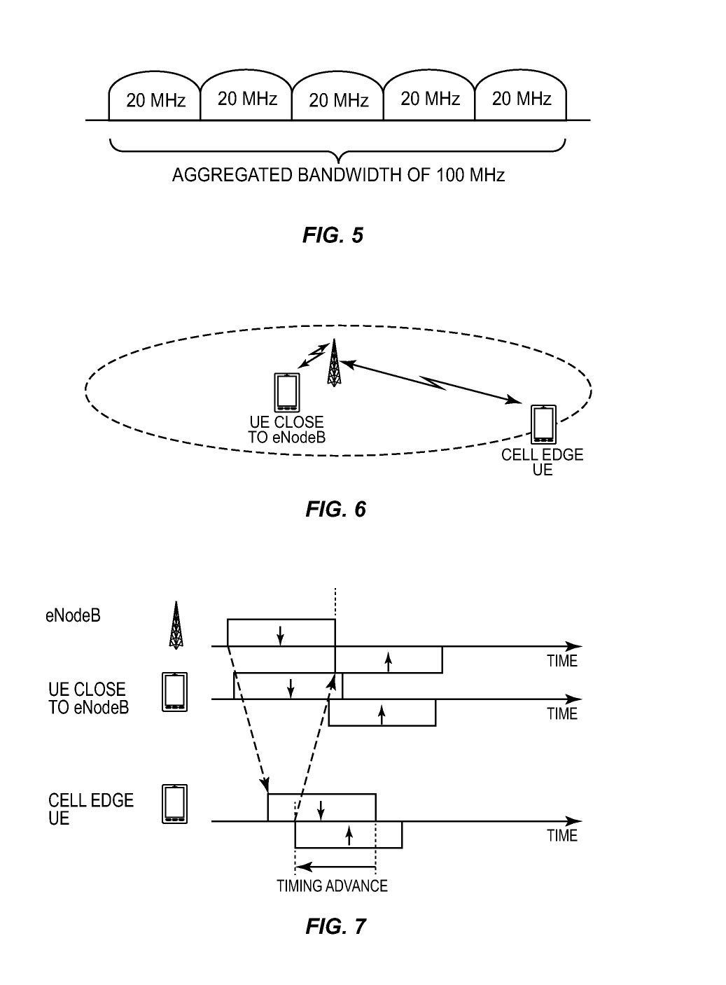

Particularly for early LTE Rel-10 deployments, it can be expected that there will be a smaller number of LTE Rel-10-capable terminals compared to many LTE legacy terminals. Therefore, it is necessary to assure an efficient use of a wide carrier also for legacy terminals, i.e., that it is possible to implement carriers where legacy terminals can be scheduled in all parts of the wideband LTE Rel-10 carrier. The straightforward way to obtain this is by use of Carrier Aggregation (CA). CA implies that an LTE Rel-10 terminal can receive multiple CC, where the CC have, or at least the possibility to have, the same structure as a Rel-8 carrier. One example of CA is illustrated in FIG. 5, depicting five contiguous 20 MHz CC aggregating to 100 MHz bandwidth. In general, CC need not be frequency-contiguous.

The Rel-10 standard support up to five aggregated carriers where each carrier is limited in the RF specifications to have a one of six bandwidths, namely: 6, 15, 25, 50, 75, or 100 RB (corresponding to 1.4, 3, 5, 10, 15, and 20 MHz, respectively).

The number of aggregated CC, as well as the bandwidth of the individual CC, may be different for uplink and downlink. A symmetric configuration refers to the case where the number of CC in downlink and uplink is the same; an asymmetric configuration refers to the case where the number of CC is different. It is important to note that the number of CC configured in the network may be different from the number of CC seen by a terminal: A terminal may for example support more downlink CC than uplink CC, even though the network offers the same number of uplink and downlink CC.

During initial access, an LTE Rel-10 terminal behaves similarly to a LTE Rel-8 terminal. Upon successful connection to the network a terminal may—depending on its own capabilities and the network—be configured with additional CC in the UL and DL. Configuration is based on Radio Resource Control (RRC). Due to the heavy signaling overhead and rather slow speed of RRC signaling, it is envisioned that a terminal may be configured with multiple CC even though not all of them are currently used. If a terminal is activated on multiple CC this would imply it has to monitor all DL CC for PDCCH and PDSCH. This implies a wider receiver bandwidth, higher sampling rates, and the like, resulting in high power consumption.

### Timing Advance

In order to preserve the orthogonality in UL, the UL transmissions from multiple UEs need to be time aligned at the eNodeB. As illustrated in FIG. 6, multiple UEs may be located at different distances from the eNodeB. Hence, the UEs need to initiate their UL transmissions at different times; a UE far from the eNodeB needs to start transmission earlier than a UE close to the eNodeB. This can for example be handled by time advance of the UL transmissions, wherein a UE starts its UL transmission before a nominal time given by the timing of the DL signal received by the UE. This concept is illustrated in FIG. 7.

The UL timing advance is maintained by the eNodeB through timing alignment commands to the UE based on measurements on UL transmissions from that UE. Through timing alignment commands, the UE is ordered to start its UL transmissions earlier or later. This applies to all UL transmissions except for random access preamble transmissions on the Physical Random Access Channel (PRACH).

There are strict relationships between DL transmissions and the corresponding UL transmission. One example is the timing between a DL-SCH transmission on PDSCH and the HARQ ACK/NACK feedback transmitted in UL (either on PUCCH or PUSCH). Another example is the timing between an UL grant transmission on PDCCH and the UL-SCH transmission on PUSCH.

By increasing the timing advance value for a UE, the UE processing time between the DL transmission and the corresponding UL transmission decreases. For this reason, an upper limit on the maximum timing advance has been defined by 3GPP in order to set a lower limit on the processing time available for a UE. For LTE, this value has been set to roughly 667 usec, which corresponds to a cell range of 100 km (note that the TA value compensates for the round trip delay).

In LTE Rel-10 there is only a single timing advance value per UE, and all UL CC are assumed to have the same transmission timing. The reference point for the timing advance is the receive timing of the primary DL CC (PCC).

In LTE Rel-11, different serving CC used by the same UE may have different timing advance values. Most likely, the serving CC sharing the same TA value will be configured by the network to belong to a so-called TA group. If at least one serving CC of the TA group is time aligned, all serving CC belonging to the same group may use this TA value. To obtain time alignment for a secondary CC (SCC) belonging to a different TA group than the PCC, the current 3GPP assumption is that network-initiated random access may be used to obtain initial TA for this SCC (and, by extension, for the TA group to which the SCC belongs).

### Random Access in LTE

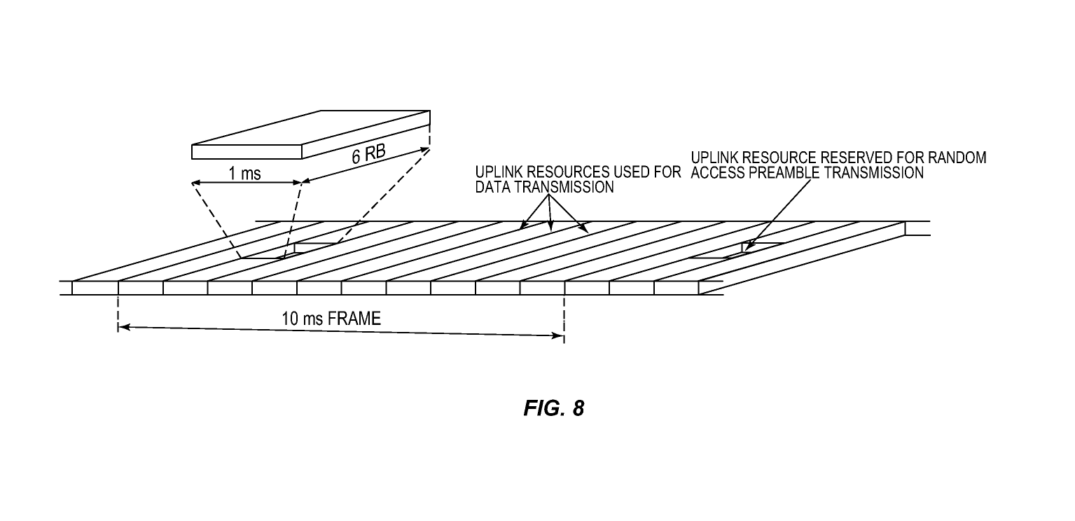

In LTE, as in any communication system, a mobile terminal (UE) may need to contact the network (via the eNodeB) without having a dedicated resource in the Uplink (from UE to eNodeB). To handle this, a random access procedure is available where a UE that does not have a dedicated UL resource may transmit a signal to the base station. The first message of this procedure is typically transmitted on a special resource reserved for random access, a Physical Random Access Channel (PRACH). In LTE, this channel is limited in time and frequency, as depicted in FIG. 8. The resources available for PRACH transmission are provided to the UE as part of broadcast system information (or as part of dedicated RRC signaling, e.g., in the case of handover).

In LTE, the random access procedure is used for a number of different reasons, including initial access; incoming handover; resynchronization of the UL; scheduling request (for a UE without resources for contacting an eNodeB); and positioning.

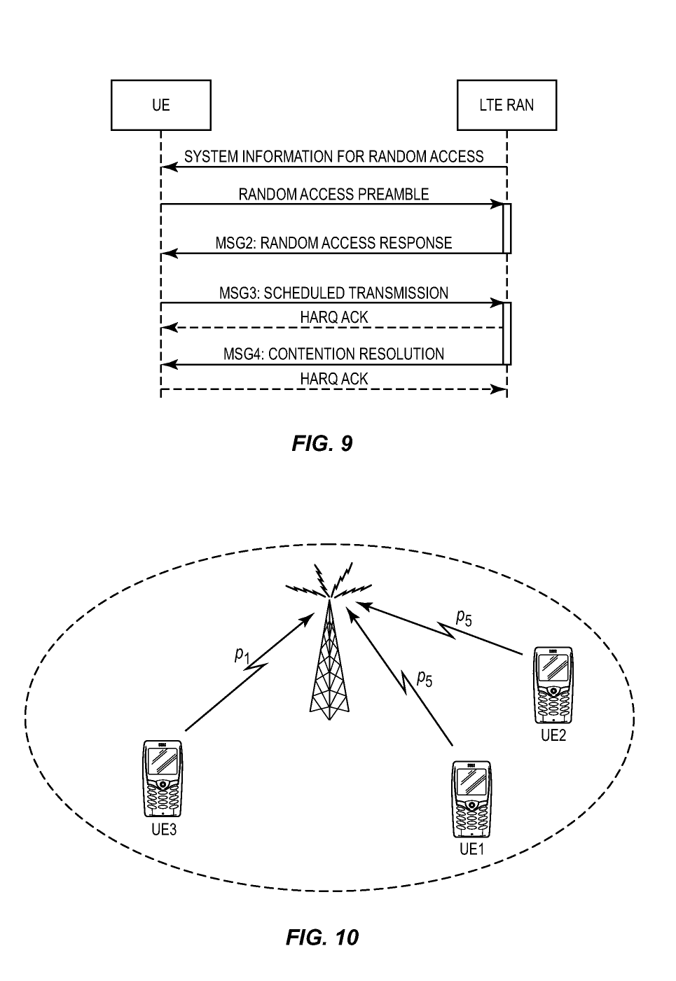

Two random access procedures are defined: contention-based and contention-free. The contention-based random access procedure used in LTE is illustrated in FIG. 9. The UE starts the random access procedure by randomly selecting one of the preambles available for contention-based random access. The UE then transmits the selected random access preamble on the Physical Random Access Channel (PRACH) to an eNodeB in the Random Access Network (RAN).

The RAN acknowledges any preamble it detects by transmitting a random access response (MSG2) including an initial grant to be used on the uplink shared channel, an identifier called the Temporary Cell-Radio Network Temporary Identifier (TC-RNTI), and a timing alignment (TA) value based on the timing offset of the preamble measured by the eNodeB on the PRACH. The MSG2 is transmitted in the DL to the UE, and its corresponding PDCCH message CRC is scrambled with the Random Access RNTI (RA-RNTI).

When receiving the response, the UE uses the grant to transmit a message (MSG3) that in part is used to trigger the establishment of Radio Resource Control and in part to uniquely identify the UE on the common channels of the CC. The timing alignment command provided in the random access response is applied to the UL transmission in MSG3. The eNodeB can change the resources blocks that are assigned for a MSG3 transmission by sending an UL grant for which the CRC is scrambled with the TC-RNTI.

A contention resolution message (MSG4) transmitted by the eNodeB has its PDCCH CRC scrambled with the C-RNTI, if the UE previously has a C-RNTI assigned. If the UE does not have a C-RNTI previously assigned, its TC-RNTI is promoted to a C-RNTI, and the PDCCH CRC is scrambled with that.

The procedure ends with RAN solving any preamble contention that may have occurred for the case that multiple UEs transmitted the same preamble at the same time. This can occur since each UE randomly selects when to transmit and which preamble to use. If multiple UEs select the same preamble for the transmission on RACH, there will be contention between these UEs that needs to be resolved through the contention resolution message (MSG4). The case when contention occurs is illustrated in FIG. 10, where two UEs transmit the same preamble, p₅, at the same time. A third UE also transmits at the same RACH, but since it transmits with a different preamble, p₁, there is no contention between this UE and the other two UEs. The contention is resolved by MSG4 scrambling the PDCCH CRC with the TC-RNTI or C-RNTI of one UE. The other UE(s) that transmitted the same preamble at the same time must restart the random access procedure.

The contention-free random access is similar to contention-based, but without the need for the contention resolution steps (MSG3 and MSG4). Contention-free random access may be initiated by the eNodeB, for example, to get a UE to achieve synchronisation in UL. The eNodeB initiates a non-contention based random access either by sending a PDCCH order or indicating it in an RRC message, as in the case of handoff.

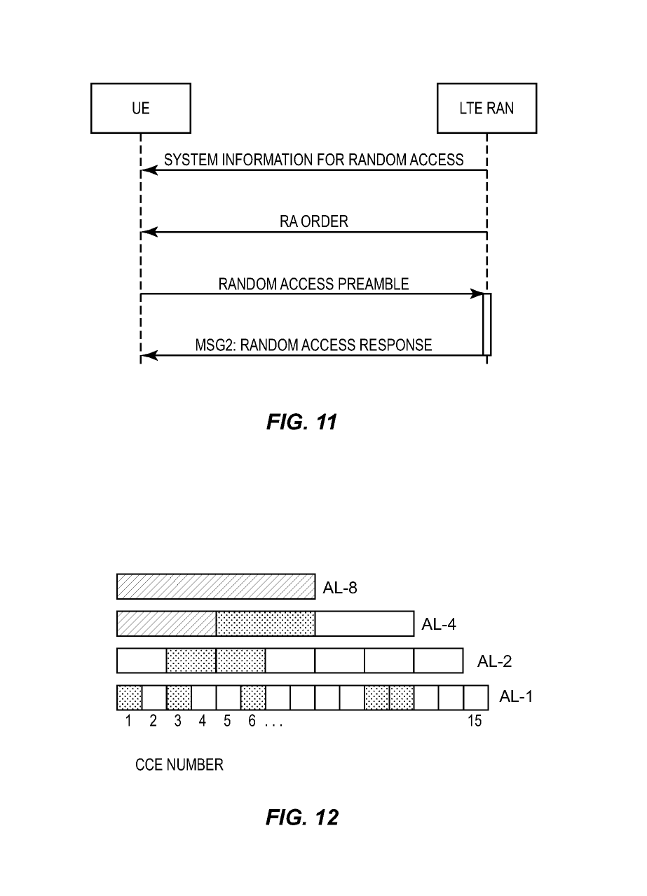

The contention-free random access procedure is illustrated in FIG. 11. In this case, the eNodeB directs the UE to begin the process through a PDCCH message. The UE complies by sending a random access preamble on the PRACH. The eNodeB then responds with a MSG2, wherein the PDCCH message CRC is scrambled with the RA-RNTI. The UE considers the contention resolution successfully completed after it has received MSG2 successfully.

For the contention-free random access, as for the contention-based random access, the MSG2 contains a timing alignment value. This enables the eNodeB to set the initial or updated timing according to the UEs transmitted preamble.

According to the 3GPP LTE Release 10 specification, in a Carrier Aggregation environment, the random access procedure is limited to the primary CC (PCC) only. This implies that the UE can only send a preamble on the PCC. Further, MSG2 and MSG3 are only received and transmitted on the PCC. However, in the Rel-10 specification, MSG4 can be transmitted on any DL CC.

In LTE Release 11, the current assumption (as of RAN2#74, June 2011) is that the random access procedure will be supported also on secondary CC (SCC), at least for the UEs supporting Rel-11 carrier aggregation. So far, only network-initiated random access on SCC is assumed.

### Power control for RACH

The power control used for the transmission of a random access preamble on the RACH is done as an open loop based on, e.g., estimated path loss and the preamble received target power, i.e., the targeted power received by the eNodeB. The received target power is typically signaled to the UE as part of system information on the broadcast channel.

Since the random access preamble transmission is a non-scheduled transmission, it is not possible for the eNodeB to employ a closed-loop correction to correct for measurement errors in the open loop estimate. Instead, a power ramping approach is used in which the UE increases its transmission power (or rather the RACH preamble received target power) between transmission attempts of the random access preamble. This ensures that even a UE with a too low initial transmission power, e.g., due to error in the path loss estimate, after a number of preamble transmission attempts will have increased its power sufficiently to be able to be detected by the eNodeB. For example, after four transmission attempts, the total ramp-up of the transmission power is

ΔPᵣₐₘₚᵤₚ=(N−1)*Δ_{ramp step}

where N is the number of transmission attempts and Δ_{ramp step} is the power ramping step size between each transmission attempt.

### PDCCH Processing

After channel coding, scrambling, modulation, and interleaving of the control information, the modulated symbols are mapped to the resource elements in the control region. To multiplex multiple PDCCH onto the control region, LTE defines control channel elements (CCE), where each CCE maps to 36 resource elements. One PDCCH can, depending on the information payload size and the required level of channel coding protection, comprise 1, 2, 4 or 8 CCEs, and the number is denoted as the CCE Aggregation Level (AL). By choosing the aggregation level, link-adaptation of the PDCCH is obtained. In total there are N_{CCE} CCEs available for all the PDCCH to be transmitted in the subframe, and the number N_{CCE} varies from subframe to subframe depending on the number of control symbols n.

As N_{CCE} varies from subframe to subframe, the terminal needs to blindly determine the position and the number of CCEs used for its PDCCH, which can be a computationally intensive decoding task. Therefore, some restrictions on the number of possible blind decodings a terminal needs to go through have been introduced. For example, the CCEs are numbered, and CCE aggregation levels of size K can only start on CCE numbers evenly divisible by K. This is depicted in FIG. 12.

The set of CCE where a terminal must blindly decode and search for a valid PDCCH are called search spaces. This is the set of CCEs on an AL that a UE should monitor for scheduling assignments or other control information. FIG. 12 depicts a representative set of search spaces for a given UE as the shaded and hatched CCEs. In each subframe and on each AL, a UE will attempt to decode all the PDCCHs that can be formed from the CCEs in its search space. If the CRC checks, then the content of the PDCCH is assumed to be valid for the UE and it further processes the received information. Often two or more UEs will have overlapping search spaces and the network has to select one of them for scheduling of the control channel. When this happens, the non-scheduled UE is said to be blocked. The search spaces vary pseudo-randomly from subframe to subframe to minimize this blocking probability.

A UE's search space is further divided to a common part (shaded in FIG. 12) and a UE-specific part (hatched in FIG. 12). In the common search space, the PDCCH containing information for all or a group of UEs is transmitted (e.g., paging, system information, and the like). If carrier aggregation is used, a UE will find the common search space present on the primary component carrier (PCC) only. The common search space is restricted to aggregation levels 4 and 8 to give sufficient channel code protection for all terminals in the cell (since it is a broadcast channel, link adaptation can not be used). The m₈ and m₄ first PDCCH (with lowest CCE number) in an AL of 8 or 4, respectively, belongs to the common search space. For efficient use of the CCEs in the system, the remaining search space is UE-specific at each aggregation level.

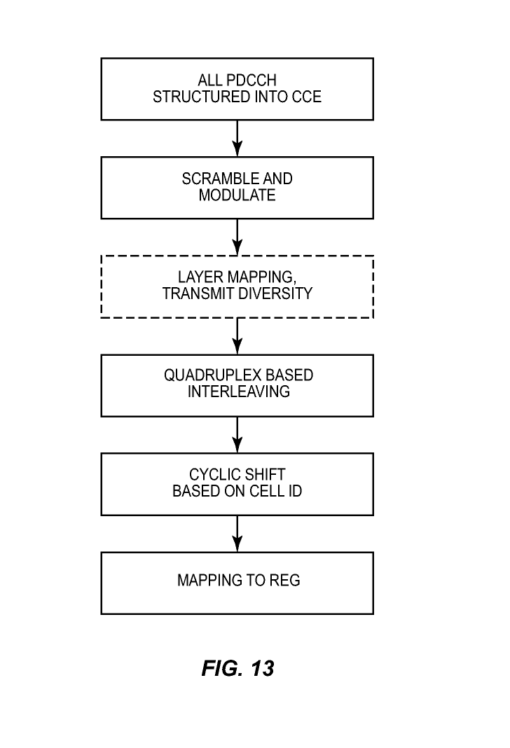

A CCE consists of 36 QPSK modulated symbols that map to the 36 RE unique for this CCE. To maximize the diversity and interference randomization, interleaving of all the CCEs is used before a CC-specific cyclic shift and mapping to Res. The processing flow is depicted in FIG. 13. Note that in most cases, some CCEs are empty due to the PDCCH location restriction to UE-specific search spaces and aggregation levels. The empty CCEs are included in the interleaving process and mapped to RE, just as any other PDCCH, to maintain the search space structure. Empty CCE are set to zero power; this power can instead be used by non-empty CCEs to further enhance the PDCCH transmission.

Furthermore, the to enable the use of four-antenna TX diversity, a group of four adjacent QPSK symbols in a CCE is mapped to four adjacent RE, denoted as an RE group (REG). Hence, the CCE interleaving is quadruplex-based (group of four), and the mapping process has a granularity of 1 REG, and one CCE corresponds to 9 REGs (=36 RE).

In general, there will also be a collection of REG that remains as “leftovers” after the set of size N_{CCE} CCEs has been determined (although the leftover REGs are always fewer than 36 RE), since the number of REGs available for PDCCH in the system bandwidth is generally not a multiple of 9 REGs. These leftover REGs are unused in the LTE system.

An LTE UE only monitors the common search space on the PCC. Further, the UE also monitors a set UE-specific search space for each of its aggregated DL/UL CC. The common search correspond to 12 blind decodes, and each UE-specific search space corresponds to either 32 or 48 blind decodes, depending whether the UE supports UL MIMO on the aggregated UL CC.

The UE monitors the following RNTI that are associated with the random access procedure for each associated search spaced on PDCCH: the RA-RNTI for MSG2 is monitored in the common search space on the PCC; the TC-RNTI for MSG3 is monitored in the common search on the PCC, for reallocating the MSG3 in frequency; the TC-RNTI for MSG4 is monitored in the common search and UE-specific TC-RNTI search space on the PCC; and the C-RNTI for MSG4 is monitored in the common search and UE-specific C-RNTI search space on the any component carrier.

### PCFICH

In order to be able to decode PDCCH (and subsequently also PDSCH), a UE must know the beginning of the PDSCH region. This value can be derived from Control Format Indicator (CFI) transmitted on the Physical Control Format Indicator Channel (PCFICH).

In the case of non-CA UE, or CA UE where PDCCH and PDSCH are transmitted on the same CC, a wrongly decoded PCFICH has no large consequence: If the UE decodes PCFICH incorrectly, it will not be able to decode PDCCH and thus it does not know it has been scheduled. Obviously, no HARQ feedback will be generated. If the eNodeB does not receive any HARQ feedback, it will resend the data using HARQ retransmission.

However, in the case of cross-carrier scheduling, the consequences of a wrongly decoded PCFICH on the CC carrying PDSCH are worse: The UE knows it has been scheduled (it decoded PDCCH on the scheduling CC correctly), but it will fail to decode PDSCH, since it starts to demodulate PDSCH using the wrong OFDM symbol. Due to this failure, the UE will report a NACK. Since the UE started to decode PDSCH with a wrong OFDM symbol, it corrupts it soft-buffer, and the UE will most likely fail to decode the data even with multiple HARQ retransmissions. To obtain the data, an expensive higher-layer RLC retransmission is required.

To mitigate this problem, the UE does not read PCFICH on a cross-scheduled SCC, but rather assumes a semi-statically configured starting position for PDSCH called “pdsch-Start.”

### Timing Adjustment for Cross-Scheduled UE

As used herein, a “cross-scheduled UE” or “cross-carrier scheduled UE” is one that is scheduled on a PCC to read the PDSCH on an aggregated carrier, or SCC. As one example of cross-carrier scheduling, consider a UE that is aggregating a large bandwidth carrier, e.g., 20 MHz, and a small bandwidth carrier, e.g., 1.4 MHz. Typically, the larger bandwidth carrier would be the PCC, and may cross-schedule the UE to use the smaller bandwidth carrier as a SCC.

As mentioned above, the normal procedure is for the UE to use the parameter pdsch-Start to ascertain the start of the PDSCH (that is, the boundary between PDCCH and PDSCH, see FIG. 4). Errors resulting from an incorrect value of pdsch-Start may be corrected in higher level signaling, e.g., RLC procedures. However, the random access procedure, including the establishment of timing adjustment parameters for the SCC, is a critical function.

The international application PCT/SE2012/050265, assigned to the assignee of the present application and incorporated herein by reference, describes the problems with the LTE Rel-10 restriction that random access procedures are limited to the PCC. In that application, it is proposed to send a random access preamble on the UL of a SCC, and monitor the DL CC that is SIB2-linked to that UL CC for MSG2 of the random access procedure, which includes the TA value (as well as TC-RNTI for the UE).

One problem with this, in the case of cross-carrier scheduling, is that a UE monitors its PCC for PDCCH, and the cross-scheduled SCC for PDSCH. The UE thus relies on the accuracy of the pdsch-Start parameter, which may be erroneous. According to one or more embodiments described herein, a UE at least temporarily monitors the PDCCH of the DL SCC associated with the UL SCC on which it transmitted a random access preamble, to read PCFICH (which is always the first OFDM symbol of PDCCH per subframe). The UE obtains the CFI from PCFICH, which indicates the length of PDCCH on the SCC, and hence the beginning of PDSCH. The UE then reads PDSCH using the reliable CFI, to read MSG2 and extract a TA value by which to adjust its UL timing to preserve coherency at the eNodeB.

In particular, the UE substitutes the common search areas (CCEs) of the DL SCC for one or more of its default search areas (either common search areas or UE-specific search areas), and thus does not increase the number of required blind decode operations. This information is configured by the eNodeB prior to the UE initiating the random access procedure on the SCC. In this manner, the UE obtains the actual CFI of the DL SCC, ensuring that it can accurately decode PDSCH to obtain MSG2. In other cases of cross-carrier scheduling, the UE may rely on the pdsch-Start parameter, and does not read PDCCH on the DL SCC.

In one embodiment, in which the UE is performing contention-free random access on the SCC, after transmitting a random access preamble on the UL SCC, the UE monitors the associated DL SCC (that is, the DL CC that is SIB2-linked to the UL CC on which it transmitted the preamble) until it is able to read MSG2 on PDSCH, or until a related timer expires.

In another embodiment, in which the UE is performing contention-based random access on the SCC, after transmitting a random access preamble on the UL SCC, the UE monitors the associated DL SCC until it is able to read MSG2 on PDSCH, transmits MSG3 on UL SCC, and additionally reads or acknowledges MSG4 on PDSCH, or until a related timer expires.

The UE may use the CFI thus obtained from DL SCC for all, or only some, of the messages related to the random access procedure—for example, MSG2 (PDCCH+PDSCH), MSG3 (PDCCH for HARQ), and MSG4 (PDCCH+PDSCH). Following the random access procedure, the UE may rely on the pdsch-Start parameter to access PDSCH.

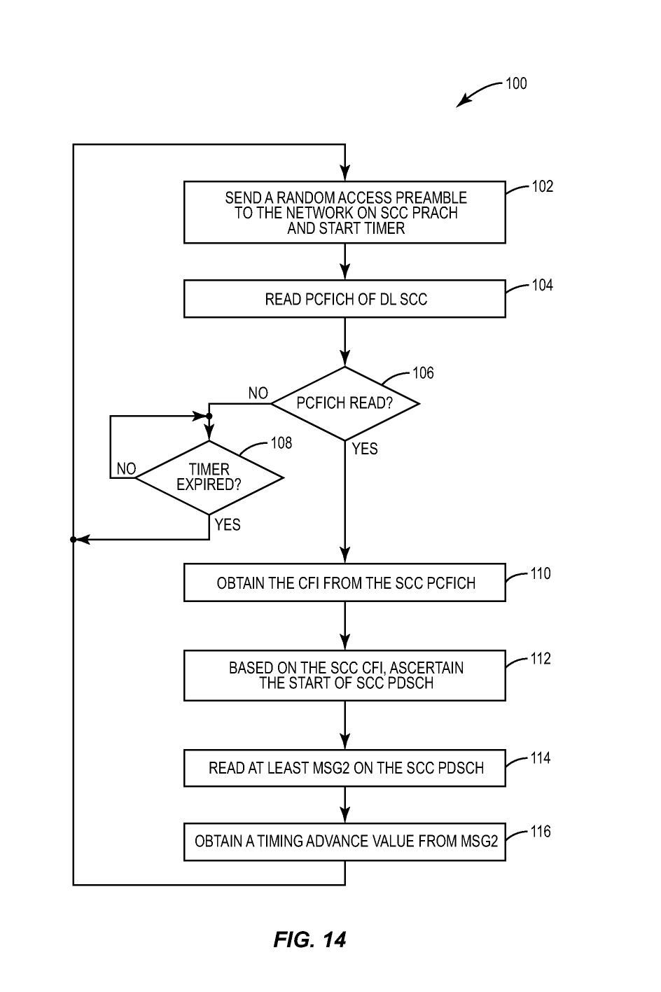

FIG. 14 depicts a method 100, by a UE, of obtaining timing advance information on SCC, when the UE is cross-scheduled by a PCC. The UE sends a random access preamble on the SCC PRACH, and starts a timer (block 103). Those of skill in the art will recognize that the Rel-10 LTE specification limits the transmission of a preamble to the PCC. The UE reads PCFICH of the DL SCC (block 104). Note that cross-scheduled UE normally read PDCCH (including PCFICH) on the DL PCC, and read PDSCH on DL SCC using the configured parameter pdsch-Start. If the UE is unable to read the PCFICH on the DL SCC (block 106) before the timer expires or otherwise reaches a predetermined value (block 108), then it abandons the random access procedure and starts another one. If the UE is able to read the PCFICH on DL SCC (block 106), it extracts the CFI from the PCFICH (block 110). The UE then uses the actual CFI, in lieu of the pdsch-Start parameter, to access the DL SCC PDSCH (block 112) and read the MSG2 message from the network (block 114). The MSG2 message includes a timing advance value calculated in response to the timing of the UE's preamble transmission. The UE extracts this timing advance value (block 116), and adjusts its DL SCC transmission timings accordingly.

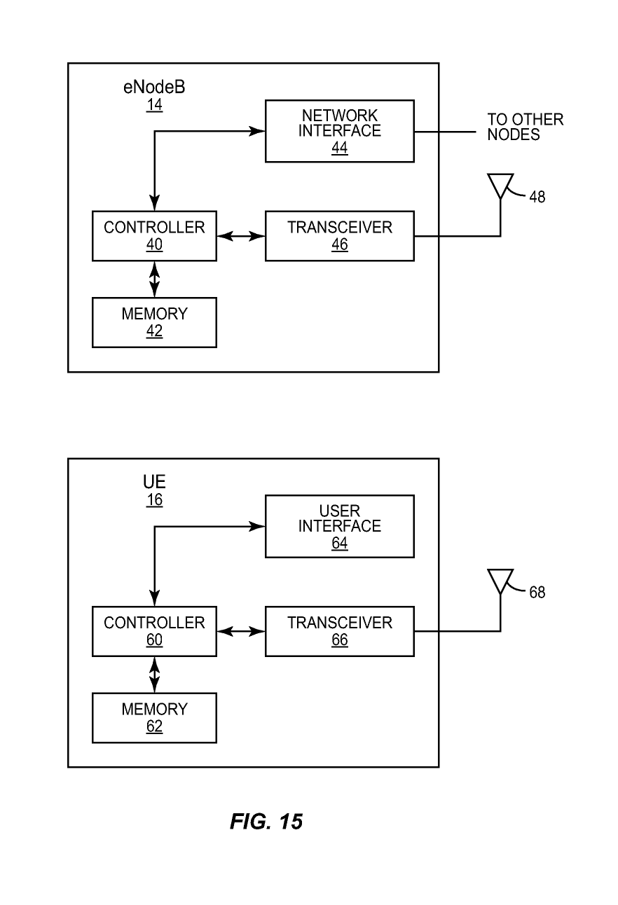

FIG. 15 depicts functional block diagrams of an eNodeB 14 and UE 16. The eNodeB 14 includes a controller 40, memory 42, network interface 46, and a transceiver 46 coupled to one or more antenna 48. Additional components of the eNodeB 14 are omitted for clarity.

The controller 40 may comprise any sequential state machine operative to execute machine instructions stored as machine-readable computer programs in the memory 42, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

The memory 42 may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like. The memory 42 is operative to store program code operative to cause the controller to operate as described herein.

The network interface 44 is operative to communicatively couple the eNodeB 14 to other LTE core network nodes, such as the MME/S-GW 22. The eNodeB may additionally be coupled to other eNodeBs 14, or other network nodes. The network interface 44 is operative to implement a variety of communication protocols over physical channel such as, but not limited to, wired electrical or optical networks.

The transceiver 66 is operative to encode and modulate data according to OFDMA techniques, and otherwise generate and process signals for transmission to UE 16 within its cell 16, according to the various 3GPP LTE specifications. The transceiver 66 is further operative to receive and process signals from UE 16 in its cell 18. The antenna 48 may comprise one antenna (or one antenna per sector), or may comprise multiple antennae in a Multiple Input Multiple Output (MIMO) configuration.

The UE 16 includes a controller 60, memory 62, user interface 64, and a transceiver 66 coupled to one or more antenna 68. Additional components of the UE 16 are omitted for clarity. The controller 60, memory 62, transceiver 66, and antenna 68 may be as describe above with respect to the eNodeB 14, with variations for low power and mobility, as know by those of skill in the art. The user interface 64 may include a microphone, speaker, keypad, display, and/or touchscreen, operative to receive voice and control inputs from a user, and operative to display information and render sounds to the user. UE 16 may include numerous additional components (e.g., camera) omitted from FIG. 14 for clarity.

According to embodiments of the present invention, a cross-scheduled UE may reliably complete a random access procedure on a SCC, to obtain a timing advance parameter for the SCC, without relying on the pdsch-Start parameter. This capability reduces expensive higher-level signaling necessary if the pdsch-Start parameter is not updated sufficiently frequently. For routine cross-scheduled traffic, the UE may use the pdsch-Start parameter and not read the DL SCC CFI.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-24. (canceled)

25. A method of obtaining timing advance information on a secondary component carrier (SCC) the method performed by User Equipment (UE) operative in a Long Term Evolution (LTE) wireless communication network employing carrier aggregation, in which the UE is scheduled on a primary component carrier (PCC) and is configured for cross-carrier scheduling to the SCC, the method comprising:
sending to the network a random access preamble on a Physical Random Access Channel (PRACH) of the SCC;
obtaining a Control Format Indicator (CFI) from the Physical Control Format Indicator Channel (PCFICH) of the SCC;
based the SCC CFI, ascertaining the start of the Physical Downlink Shared Channel (PDSCH);
reading at least a random access response message, denoted as MSG2, on the PDSCH of the SCC; and
obtaining a timing advance value from the MSG2.

26. The method of claim 25, wherein sending the random access preamble on the SCC PRACH is done in response to a command received from the network on the PCC.

27. The method of claim 25, wherein reading the PCFICH of the SCC comprises deriving the resource element groups to which the PCFICH is allocated.

28. The method of claim 25, further comprising:
upon sending the random access preamble on RACH, starting a first timer; and
monitoring the PCFICH on the SCC until the earlier of: receipt of MSG2 or the first timer reaches a predetermined value.

29. The method of claim 25, further comprising:
sending a message to the network on SCC, the message conforming to the timing advance value obtained from MSG2, and including a unique identifier of the UE.

30. The method of claim 29, further comprising receiving a contention resolution message, denoted as MSG4, from the network on the PDSCH of the SCC, the MSG4 being directed to the UE.

31. The method of claim 30, further comprising:
upon sending the random access preamble on RACH, starting a second timer; and
monitoring the PCFICH on the SCC until the earlier of: receipt or acknowledgement of MSG4 or the second timer reaching a predetermined value.

32. The method of claim 30, wherein receiving MSG4 comprises searching one or more UE-specific search spaces of CCE on the SCC.

33. The method of claim 32, wherein searching the UE-specific search space on the SCC comprises searching for a Cell-Radio Network Temporary Identifier (C-RNTI) or a Temporary C-RNTI (TC-RNTI).

34. A method of transmitting timing advance information on a secondary component carrier (SCC) to User Equipment (UE), the method performed by an evolved Node B (eNodeB) operative in a Long Term Evolution (LTE) wireless communication network employing carrier aggregation, in which the UE is scheduled on a primary component carrier (PCC) and is configured for cross-carrier scheduling to the SCC, the method comprising:
receiving from the UE a random access preamble on a Physical Random Access Channel (PRACH) of the SCC;
calculating a timing advance value for the UE based on the timing of receipt of the random access preamble on the SCC PRACH;
transmitting a Control Format Indicator (CFI) on a Physical Control Format Indicator Channel (PCFICH) of the SCC; and
transmitting a random access response message, denoted as MSG2, on the Physical Downlink Shared Channel (PDSCH) of the SCC;
wherein the MSG2 includes the calculated timing advance value.

35. The method of claim 34, further comprising receiving a message from the UE on SCC, the message conforming to the timing advance value sent in the MSG2, and including a unique identifier of the UE.

36. The method of claim 35, further comprising transmitting to the UE a contention resolution message, denoted as MSG4, on the PDSCH of the SCC.

37. A User Equipment (UE) operative in a Long Term Evolution (LTE) wireless communication network employing carrier aggregation, comprising:
one or more antennas;
a transceiver operatively connected to the one or more antennas;
memory; and
a controller operatively connected to the transceiver and memory and configured to establish communication with an eNodeB and receive scheduling on a primary component carrier (PCC) including cross-scheduling to a secondary component carrier (SCC) and further operative to
cause the transceiver to send to the network a random access preamble on a Physical Random Access Channel (PRACH) of the SCC;
cause the transceiver to obtain a Control Format Indicator (CFI) from the Physical Control Format Indicator Channel (PCFICH) of the SCC;
based the SCC CFI, ascertain the start of the Physical Downlink Shared Channel (PDSCH);
cause the transceiver to read at least a random access response message, denoted as MSG2, on the PDSCH of the SCC; and
obtain a timing advance value from the MSG2.

38. The UE of claim 37, wherein the controller is configured to cause the transceiver to send to the network a random access preamble on a PRACH of the SCC in response to a command received from the network on the PCC.

39. The UE of claim 37, wherein the controller is configured to read the PCFICH of the SCC by reading one or more resource element groups on the SCC.

40. The UE of claim 37, wherein the controller is further configured to:
start a first timer upon causing the transceiver to send the random access preamble on the RACH; and
cause the transceiver to monitor the PCFICH on the SCC until the earlier of:
receipt of MSG2 or the first timer reaching a predetermined value.

41. The UE of claim 37, wherein the controller is further configured to:
cause the transceiver to send a message to the network on SCC, the message conforming to the timing advance value obtained from MSG2, and including a unique identifier of the UE.

42. The UE of claim 41, wherein the controller is further configured to cause the transceiver to receive or acknowledge a contention resolution message, denoted as MSG4, from the network on the PDSCH of the SCC, the MSG4 being directed to the UE.

43. The UE of claim 42, wherein the controller is further configured to:
start a second timer upon causing the transceiver to send the random access preamble on the RACH; and
cause the transceiver to monitor the PCFICH on the SCC until the earlier of:
receipt of MSG4 or the second timer reaching a predetermined value.

44. The UE of claim 42, wherein the controller is configured to cause the cause the transceiver to search one or more UE-specific search spaces of CCE on any component carrier, for receiving the MSG4.

45. The UE of claim 44, wherein the search of the UE-specific search space on the SCC comprises searching for a Cell-Radio Network Temporary Identifier (C-RNTI) or a Temporary C-RNTI (TC-RNTI).

46. An eNodeB operative in a Long Term Evolution (LTE) wireless communication network employing carrier aggregation, comprising:
one or more antennas;
a transceiver operatively connected to the antenna;
memory; and
a controller operatively connected to the transceiver and memory, and configured to establish communication with a User Equipment (UE) and schedule the UE on a primary component carrier (PCC) and further operative to cross-schedule the UE on a secondary component carrier (SCC);
said controller further configured to:
cause the transceiver to receive from the UE a random access preamble on a Physical Random Access Channel (PRACH) of the SCC;
calculate a timing advance value for the UE based on the timing of receipt of the random access preamble on the SCC PRACH;
cause the transceiver to transmit a Control Format Indicator (CFI) on a Physical Control Format Indicator Channel (PCFICH) of the SCC; and
cause the transceiver to transmit a random access response message, denoted as MSG2, on the Physical Downlink Shared Channel (PDSCH) of the SCC;
wherein the MSG2 includes the calculated timing advance value.

47. The eNodeB of claim 46, wherein the controller is further configured to cause the transceiver to receive a message from the UE on SCC, the message conforming to the timing advance value sent in the MSG2, and including a unique identifier of the UE.

48. The eNodeB of claim 47, wherein the controller is further configured to cause the transceiver to transmit to the UE a contention resolution message, denoted as MSG4, on the PDSCH of the SCC.
